(19) United States
(12) Patent Application Publication
(10) Pub. No.: US 2007/0002163 A1
(43) Pub. Date: Jan. 4, 2007

(54) Imager settings

(76) Inventors: Dariusz Madej, Shoreham, NY (US); Miroslav Trajkovic, Coram, NY (US)

Correspondence Address: FAY KAPLUN & MARCIN, LLP, 15O BROADWAY, SUITE 702, NEW YORK, NY, 10038, US

(21) Appl. No.: 11/170,335

(22) Filed: Jun. 29, 2005

(51) Int. Cl. G03B 7/00; H04N 5/235

(52) U.S. Cl. 348/362

(57) ABSTRACT

Methods and apparatus for adjusting image capture settings, such as, for example, exposure time and external illumination through determining ambient luminance conditions prior to a request to analyze a captured image. Since image capture settings are determined before an analyze request, a device can use images captured before or very close to the request to decode a target dataform.

### FIELD OF THE INVENTION

The invention is directed to handheld imaging scanners, and more particularly to using images acquired before a decoding initiation to determine imager settings, such as, for example, exposure time, illumination setting, and evaluate whether the images acquired before decoding initiation are suitable for decoding.

### BACKGROUND OF THE INVENTION

There are numerous standards for encoding numeric and other information in visual form, such as the Universal Product Codes (UPC) and/or European Article Numbers (EAN). These numeric codes allow businesses to identify products and manufactures, maintain vast inventories, manage a wide variety of objects under a similar system and the like. The UPC and/or EAN of the product is printed, labeled, etched, or otherwise attached to the product as a dataform.

Dataforms are any indicia that encode numeric and other information in visual form. For example, dataforms can be barcodes, two dimensional codes, marks on the object, labels, signatures, signs etc. Barcodes are comprised of a series of light and dark rectangular areas of different widths. The light and dark areas can be arranged to represent the numbers of a UPC. Additionally, dataforms are not limited to products. They can be used to identify important objects, places, etc. Dataforms can also be other objects such as a trademarked image, a person's face, etc.

Scanners that can read and process the dataforms have become common. Different scanning technology include laser scanning technology and image scanning technology. In laser scanning, a laser is scanned across the dataform and light reflected from the dataform is analyzed to obtain information. In image scanning, an imager captures a digital image of the dataform and analyzes the image to obtain information.

Incorrect image capture settings of an imager can lead to capturing an under/over-exposed and/or motion-blurred image. In such cases, the quality of the captured image may not be sufficient to decode a dataform. This in turn can lead to delays in the ultimate decoding of the dataform because it takes time before the low quality image is rejected by the imager and for the imager to correct its settings, take a new image and analyze the newly captured image. Accordingly, there is a need for devices that can quickly decode dataforms.

### SUMMARY OF THE INVENTION

The invention as described and claimed herein satisfies this and other needs, which will be apparent from the teachings herein.

Image capture settings in a device, such as, for example, an imager, can be adjusted before an analyze request, such as, for example, a trigger poll, so that images taken around the time of an analyze request are of high enough quality to be used to decode a target dataform. Various exemplary imagers continuously capture images using an exposure time. In accordance with the invention, the device can determine a luminance level based on one or more of the captured images. Then, the device can adjust its exposure time based on the determined luminance level. For example, increasing its exposure time as the ambient luminance level decreases. If the exposure time and the image luminance seem to be appropriate for successful decoding, then this information can be stored together with the image and later referenced by decoding software.

When an analyze request is received by the device, the device can use an image captured within a short amount of time around the analyze request to decode a target dataform. Since images are captured using an exposure time adjusted for the current ambient luminance levels, the quality of the captured image will likely be high enough to decode a dataform.

In different embodiments of the invention, a luminance level can be determined through a plurality of different methods. For example, a luminance level can be determined based on the average pixel level value, a dominant pixel level value, a brightness level of light areas, a darkness level of dark areas, and/or using a contrast value. The luminance level can be single value determined from one or more characteristics of captured images, or the luminance level can be a set of values.

In some embodiments of the invention, in order to save power and/or to use more sophisticated/time consuming luminance algorithm luminance levels can be determined for every other captured imaged, every third image, a random image, etc. In addition, the number of times a luminance level is determined can be variable, for example, if the same luminance level is detected continuously, then the luminance algorithm can be used less and when a considerably different luminance level is determined, the algorithm is used more frequently.

When an object is placed in front of an imager the ambient luminance level from the imager's perspective may be affected. Therefore, in some embodiments of the invention a luminance level is determined assuming an object to be scanned is in a field of view of the imager.

In addition, in alternate embodiments of the invention, the image characteristics, such as, for example, the luminance levels and imager settings of previously successfully decoded images can be examined and compared to current luminance levels in order to adjust current image capture settings.

In some situations, the ambient luminance levels are too low and/or the exposure time required to capture an adequate image has become too long. In this case the imager provides external illumination in order to capture a decodable image. Since the imager knows the intensity of the illumination it can adjust its exposure time to capture a decodable image. The imager illumination intensity can be variable or fixed.

An imager uses different settings for various situations. For example, an imager is a presentation mode can have a longer exposure time than an imager in a swipe mode, since a target dataform is likely in motion in a swipe mode. If an imager is in a power save mode, it can perform luminance calculations less frequently, while if the imager is optimized for speed, it can perform luminance calculations for every captured image.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates an exemplary device implemented in accordance with an embodiment of the invention.

FIG. 2 illustrates an exemplary image capture setting method implemented in accordance with an embodiment of the invention.

### DETAILED DESCRIPTION OF EXEMPLARY EMBODIMENTS

There will now be shown and described in connection with the attached drawing figures several exemplary embodiments of methods and apparatus for applying imager settings.

In various imagers, images are captured continuously even though a decode request has not been received by the device. For example, an imager can capture 30 frames a second. Most of the captured images are discarded without any processing. When the device receives a request to decode a dataform, it applies a decoding operation to the last or last few images captured. Since presumably, the user who requested the decode operation is pointing the imager at a target dataform when they initiated the request, the target dataform appears in the last image captured and can be decoded.

Dataform decoding can fail or be delayed if the captured images are not clear enough to decode a target dataform. Captured images may not be clear because the imager's capture settings, such as, for example exposure time, and illumination settings were not optimized for a particular lighting and/or for a swipe or a presentation mode. Therefore, an imager may waste time trying to decode a low quality image In addition, dataform decoding can also be delayed if a device adjusts its settings after a decoding request is received. Thus, an exemplary imager implemented in accordance with an embodiment of the invention comprises methods for estimating imager setting prior to a decode request.

For example, instead of just discarding captured images, an imager device can determine an ambient luminance level from the captured images prior to an analyze request. Then the imager device can use the luminance level to adjust its settings. For example, a low light situation may require a longer exposure time. Having adjusted its image capture settings prior to receiving an analyze request, in bright lighting conditions, every image captured by the device can immediately be used to decode a target dataform, or, in darker lighting conditions, the device is prepared to properly illuminate and capture a target dataform. An imager may also evaluate whether the images captured prior to decoding request are appropriate for decoding based on a luminance level and exposure time and can store this information together with the image for further use by a decoder.

In various embodiments of the invention, the imager device can be designed to analyze luminance levels on every captured image. In other embodiments, luminance levels are taken less often. The more often luminance levels are determined the better the device adjusts to quick changes in ambient light. For example, if the device is faced down on a table, or if the device is pulled from a pocket.

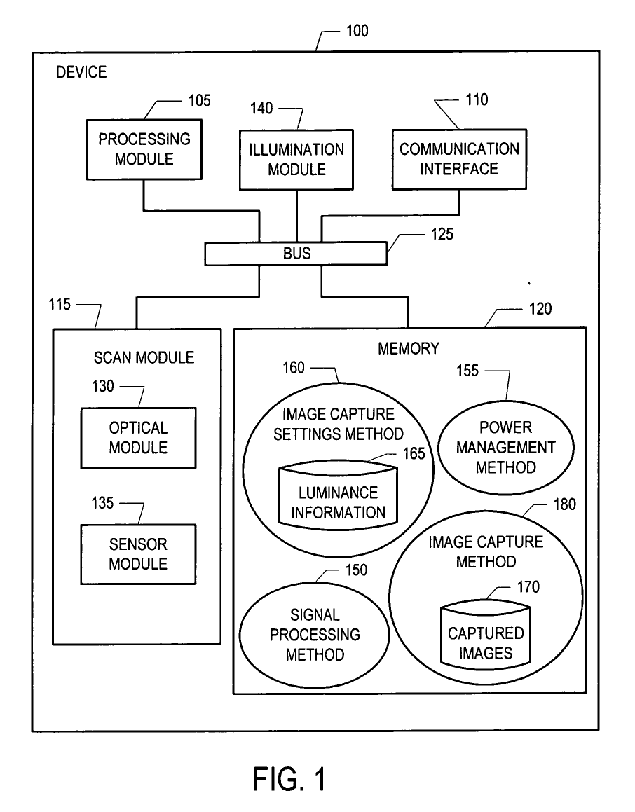

FIG. 1 illustrates an exemplary device 100 implemented in accordance with an embodiment of the invention. The device 100 can be, in exemplary embodiments, a handheld scanner, mobile computer, a terminal, etc. The device 100 comprises a processing module 105, an illumination module 140, a communication interface 110, scan module 115 and memory 120 coupled together by bus 125. The modules of device 100 can be implemented as any combination of software, hardware, hardware emulating software, and reprogrammable hardware. The bus 125 is an exemplary bus showing the interoperability of the different modules of the device 100. In various embodiments, there may be more than one bus, and in some embodiments certain modules may be directly coupled instead of coupled to a bus 125. Additionally, some modules may be combined with others.

Processing module 105 can be implemented as, in exemplary embodiments, one or more Central Processing modules (CPU), Field-Programmable Gate Arrays (FPGA), etc. In an embodiment, the processing module 105 can comprise a general purpose CPU. In other embodiments, modules of the processing module 105 may be preprogrammed or hardwired, in the processing module's 105 memory, to perform specific functions. In alternate embodiments, one or more modules of processing module 105 can be implemented as an FPGA that can be loaded with different processes, for example, from memory 120, and perform a plurality of functions. Processing module 105 can comprise any combination of the processors described above.

Scan module 115 comprises an optical module 130 and a sensor 135. The optical module can be a lens or a combination of lens, mirrors and other optical components. Sensor 135 can be implemented as, for example, a CCD or a CMOS sensor. While optical module 130 and sensor module 135 are illustrated as part of scan module 115, in alternate embodiments the optical module 130 and the sensor module 135 may be independent modules and may be used in other functions of the device 100.

Illumination module 140 may be implemented as a light emitting diode (LED), an incandescent light, a halogen light, etc. In accordance with an embodiment of the invention, the illumination module 140 can be controlled to turn on only when necessary. For example, the device 100 can illuminate a target dataform in a decoding operation when the device 100 determines that the ambient luminance levels are too low, and the exposure time has become too long. In alternate embodiments, the illumination module 140 can have variable illumination intensities.

Communication interface 110 represents a device module that can comprise communication components that allow the device 100 to communicate with other devices, computers, terminals, base stations, etc. For example, the interface 110 can be a modem, a network interface card (NIC), a port for a wire, an antenna, etc. In addition, the communication interface 110 also represents input components of the device 100. For example, various embodiments of the device 100 can comprise a keypad, a touch screen, a microphone, a thumbwheel, a trigger, etc.

In an embodiment of the invention, the device 100 receives power and information from the same communication interface 110, such as, for example, USB or an Ethernet interface. In other embodiments, communication interface 110 can be dedicated to transmitting information and a separate interface is used to obtain power, or power can be obtained from an internal power source, for example, in a wireless embodiment.

Memory 120 can be implemented as volatile memory, non-volatile memory and rewriteable memory, such as, for example, Random Access Memory (RAM), Read Only Memory (ROM) and/or flash memory. Memory 120 is illustrated as a single module in FIG. 1, but in some embodiments, memory 120 can comprise more than one memory module and some memory 120 can be part of other modules of the device 100, such as, for example, processing module 105.

An exemplary device 100, such as, for example, a handheld scanner, can store in memory a signal processing method 150, an image capture method 180, a power management method 155 and an image capture settings method 160.

Power management method 155 manages the power used by a device 100. In some embodiments, the device 100 can switch to a power save mode, when no activity is detected for a given amount of time. The power save mode can completely shut down the device 100 or alternatively, it can slow down device operations, or initiate other power saving techniques.

Device 100 uses image capture method 180 to capture images. Some devices 100 capture images continuously, and other device can capture images in response to an image capture request. The device 100 can use memory 120 to stored captured images 170 for decoding or for other device 100 functions.

In an exemplary imager device, when a decoding operation is initiated, for example, a trigger is pressed, the device analyzes a captured image to find a target dataform, for example, a barcode, and then the barcode is decoded to obtain information. Signal processing method 150 is used by the device 100 to perform these operations.

Device 100 also comprises image capture settings method 160, which comprises luminance information 165. In accordance with an embodiment of the invention, the device 100 uses image capture settings method 160 to estimate an ambient luminance level, and properly adjust image capture settings to the luminance level. A more detailed description of an exemplary image capture settings method is described below.

The exemplary embodiment of FIG. 1 illustrates signal processing method 150, power management method 155, image capture method 180 and image capture settings module 160 as separate components, but these methods are not limited to this configuration. Each method and database, described herein, in whole or in part can be separate components or can interoperate and share operations. Additionally, although the methods are depicted in the memory 120, in alternate embodiments the methods can be incorporated permanently or dynamically in the memory of other device modules, such as, for example, processing module 105.

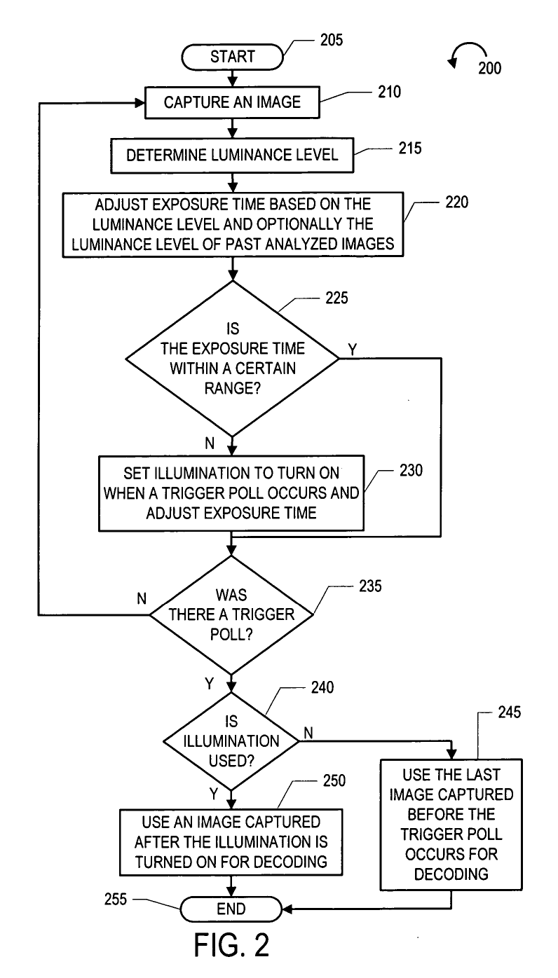

FIG. 2 illustrates an exemplary image capture settings method 200 implemented in accordance with an embodiment of the invention. Method 200 is an exemplary embodiment of image capture settings method 160 of device 100. Method 200 begins in step 205 with, for example, an imager device powering up. The method 200 proceeds to step 210 where the device captures an image, for example, using image capture method 180.

Following image capture step 210, processing proceeds to step 215, where a luminance level of the captured image is determined. For example, the device 100 can perform a statistical analysis of the pixel values of the captured image. Some of the algorithms used to determine luminance levels comprise average pixel values, dominant pixel level values, brightness of light areas, darkness of dark areas, or contrast levels. The luminance level can be a single value produced from one or more statistical analyses or the luminance level can be a set of values representing different pixel characteristics.

In some embodiments, the luminance level of a captured image can be affected if a dataform is placed in the field of view of the device 100. For example, a light source is emanating from the center of the field of view of the device 100 and will likely be blocked when an object is placed in front of the device 100. Therefore, in some embodiments of the invention, the device 100 can estimate a luminance assuming that an object is in its field of view. For example, the device 100 can lower pixel values in the center of its field of view.

Processing proceeds from step 215, to step 220, where the device 100 adjusts its exposure time based on the luminance level. For example, if the captured image is too dark, then the exposure time can be increased. In an embodiment of the invention, the exposure time is adjusted to a predetermined value based on the luminance level detected. In alternate embodiments, the exposure time can be slightly increased or decreased, and luminance levels can be determined on a subsequent captured image. If the image is still too dark or bright the exposure time is increased or decreased again. This process is repeated until the luminance level of a captured image is in a desired range. In addition, in some embodiments, the luminance levels of successfully decoded images, and even unsuccessfully decoded images can be used to adjust the exposure time to a proper level. For example, if a sequence of similar luminance levels consistently produces decodable images, then that luminance level can be favored in future decoding operations.

There are limits to how long the exposure time of a device 100 can be. For example, if the exposure time becomes too long, the device 100 can take blurry images that are difficult or impossible to decode. Therefore, in step 225, the device determines if the exposure time is within a certain range. Based on exposure time and an illumination level an image can be labeled as suitable or unsuitable for decoding, this information can be stored together with the image.

The desired range can change depending on the mode of the device 100. For example, if the device is in a presentation mode, users typically point the imager at a dataform or present the dataform in front of the imager. Since the dataform remains relatively still with respect to the imager, the imager can use a longer exposure time and obtain an image that is not that blurry. On the contrary, when an imager is in a swipe mode, the exposure time should be limited to a faster range since dataforms are moving past the imager. In a power save mode, the device 100 might risk using a longer exposure time, instead of using its illumination, while in a speed optimization mode, quicker exposure times are used. Exposure time ranges can be static and predetermined, or in alternate embodiments the luminance levels and exposure times of past analyzed images can also be used to properly adjust exposure time ranges.

If the adjusted exposure time is within a certain range, then illumination from the device 100 is not needed and processing proceeds directly to step 235. Returning to step 225, if the adjusted exposure time is outside of the range, processing proceeds from step 225, to step 230. In step 230, the illumination module 140 is set to turn on when a trigger poll occurs.

Since the device 100 is providing additional illumination, the exposure time of the device 100 is adjusted to account for the illumination. For example, the adjusted exposure time can be determined based on one or more of the luminance level of the capture image, the power of the illumination module 140, and the reading ranges of the device 100. In various embodiments of the invention, the intensity of the illumination module 140, can be variable. Therefore, the device 100 illuminates dataforms only to the extent that is necessary to obtain a decodable image. The luminance levels of past decoded images can be used to determine the necessary level of illumination intensity.

In some embodiments of the invention, the device 100 can set its illumination module 140 to turn on when a trigger poll occurs, when luminance levels drop below a certain level, without ever adjusting exposure time.

Following step 230, processing proceeds to step 235 where the device 100 waits for a trigger poll. In exemplary method 200, the device waits for a trigger poll to process an image. In alternate embodiments, the device 100 may process an image because of a request generated by another device, in response to sensing motion, etc. If no trigger poll occurs, then processing returns to step 210, where the device 100 captures another image. Steps 210 through 235 are repeated until a trigger poll occurs.

In various embodiments of the invention, luminance level determinations are not performed for every captured image. For example, when the device 100 repeatedly obtains the same luminance levels for a number of captured images, in order to save processing power, the device 100 can reduce the number of times luminance levels are determined. If a different luminance level is obtained, the device 100 can return to analyzing every captured image.

In addition, in alternate embodiments, the device 100 can use a sophisticated and time consuming algorithm to determine the luminance level of a captured image. This sophisticated algorithm can take more time to complete than capturing a single frame, thus every image is not analyzed for luminance. Therefore, depending on the situation and a desired result, device performance can be improved using many quick luminance determinations on every captured image, and device performance can be improved using more sophisticated algorithms that analyze less than every captured image.

When a trigger poll occurs, processing proceeds from step 235 to step 240. In step 240, the device 100 determines which image it should use to decode a dataform. If illumination is not used, then the luminance level of images captured immediately before the trigger poll are within a decodable range. Thus, processing proceeds to step 245, where the device 100 uses the last image, or several latest images, captured before the trigger poll occurred to decode a dataform. Adjusting device image capture settings prior to a trigger poll allows the device 100 to have images readily available to decode, and thus increases the performance of the device 100. In addition, the illumination module 140 can be selectively activated to save power. Following step 245, processing either returns to step 210 or ends in step 255, for example with the device 100 powering down.

Returning to step 240, if the illumination module 140 is set to turn on in response to a trigger poll, processing proceeds to step 250, where the device 100 uses an image captured after the illumination module 140 is turned on. Determining luminance levels prior to the trigger poll allows the device 100 to know before hand that illumination is required. Therefore, no time is wasted trying to decode dark images. Following step 250, processing either returns to step 210 or ends in step 255, for example with the device 100 powering down.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. A method of analyzing a dataform comprising:
capturing images continuously at an exposure time;
determining a luminance level based on a captured image;
adjusting said exposure time based on said luminance level; and
in response to an analyze request, analyzing an image captured within a short amount of time around the analyze request.

2. The method of claim 1 wherein said analyze request is one of a bar code decode request, a trigger poll and motion detection.

3. The method of claim 1, wherein said luminance level is determined based on at least one of an average pixel level value, a dominant pixel level value, a brightness level of light areas, a darkness level of dark areas, and contrast.

4. The method of claim 1, wherein said luminance level is a set of values.

5. The method of claim 1, wherein said luminance level is determined for every captured image.

6. The method of claim 1, wherein said luminance level is determined assuming an object to be scanned in a field of view of a scanner.

7. The method of claim 1, wherein the step of adjusting said exposure time further comprises using image characteristics of past analyzed images to adjust said exposure time.

8. The method of claim 1, further comprising the step of determining the suitability of decoding for a captured image.

9. The method of claim 1, further comprising:
in response to one of said exposure time exceeding a certain level and said luminance level being below a certain level,
setting an illumination module to illuminate a dataform in response to an analyze request, and
adjusting said exposure time; and
in response to an analyze request, analyzing an image captured while said illumination module is on instead of analyzing an image captured within a short amount of time around the analyze request.

10. The method of claim 9, wherein said exposure time is adjusted based on at least one of an illumination intensity, a luminance level of a captured image and an image quality of an analyzed image.

11. The method of claim 9, wherein illumination from said illumination module is adjustable.

12. The method of claim 9, wherein said certain exposure time level is determined based on at least one of whether a scanning device is in a presentation mode, whether said scanning device is in a swipe mode, whether said scanner is in a power save mode and whether said scanner is in a speed optimizing mode.

13. A method of decoding a dataform comprising:
capturing images continuously at an exposure time;
determining a luminance level based on a captured image;
in response to said luminance level being below a certain level,
setting an illumination module to illuminate a dataform in response to an analyze request; and
in response to an analyze request, analyzing an image captured while said illumination module is on.

14. A method of decoding a dataform comprising:
capturing images continuously at an exposure time;
determining a luminance level based on a captured image;
adjusting said exposure time based on said luminance level, wherein if said exposure time exceeds a certain level, setting an illumination module to illuminate a dataform in response to a decoding request, and using an illumination intensity level when adjusting said exposure time; and
in response to a request to decode a dataform, executing one of analyzing an image captured while said illumination module is on, and analyzing an image captured within a short amount of time around the decoding request is received.

15. An imager comprising:
a processing module;
an optical module;
a sensor; and
memory having stored thereon at least one process for,
capturing images continuously at an exposure time,
determining a luminance level based on a captured image, adjusting said exposure time based on said luminance level, and
in response to an analyze request, analyzing an image captured within a short amount of time around the analyze request.

16. The imager of claim 15, wherein said luminance level is determined based on at least one of an average pixel level value, a dominant pixel level value, a brightness level of light areas, a darkness level of dark areas, and contrast.

17. The imager of claim 15, wherein said luminance level is a set of values.

18. The imager of claim 15, wherein said luminance level is determined for every captured image.

19. The imager of claim 15, wherein the step of adjusting said exposure time further comprises using image characteristics of past analyzed images to adjust said exposure time.

20. The imager of claim 15, further comprising an illumination module, and wherein said memory further comprises at least one process for,
in response to one of said exposure time exceeding a certain level and said luminance level being below a certain level,
setting an illumination module to illuminate a dataform in response to an analyze request, and
adjusting said exposure time; and
in response to an analyze request, analyzing an image captured while said illumination module is on instead of analyzing an image captured within a short amount of time around the analyze request.

21. The imager of claim 20, wherein said exposure time is adjusted based on at least one of an illumination intensity, a luminance level of a captured image and an image quality of an analyzed image.

22. The imager of claim 20, wherein illumination from said illumination module is adjustable.

23. The imager of claim 20, wherein said certain exposure time level is determined based on at least one of whether a scanning device is in a presentation mode, whether said scanning device is in a swipe mode, whether said scanner is in a power save mode and whether said scanner is in a speed optimizing mode.
